(19) United States
(12) Patent Application Publication
(10) Pub. No.: US 2018/0220621 A1
(43) Pub. Date: Aug. 9, 2018

(54) Cat Window Structure and Method

(71) Applicant: James Donald Koskey, JR., Manitou Springs, CO (US)

(72) Inventor: James Donald Koskey, JR., Manitou Springs, CO (US)

(21) Appl. No.: 15/421,790

(22) Filed: Feb. 1, 2017

Related U.S. Application Data
(63) Continuation-in-part of application No. 14/886,063, filed on Oct. 18, 2015.

(51) Int. Cl. A01K 1/035; A01K 1/03; E06B 7/28

(52) U.S. Cl. CPC A01K 1/035; E06B 7/28; A01K 1/033

(57) ABSTRACT

The invention is directed to a cat window structure that has a number of glass attachment devices. A shell is connected to the glass attachment devices. The shell and a section of a window form a housing. An opening is formed in the housing that provides access and egress for a cat. In one case, the shell is made of a fabric covered foamed plastic and the glass attachment devices are suction cups.

The shell along with the window provides an enclosed structure that makes the cat feel safe. A bubble pod in the shell allows the cat to see out of the housing and the owner to see into the shell.

### RELATED APPLICATIONS

The present application is a continuation-in-part of and claims priority on U.S. patent application Ser. No. 14/886,063, filed on Oct. 18, 2015, and hereby incorporated by reference.

### STATEMENT REGARDING FEDERALLY SPONSORED RESEARCH

Not Applicable

### THE NAMES OF THE PARTIES TO A JOINT RESEARCH AGREEMENT

Not Applicable

### REFERENCE TO A SEQUENCE LISTING, A TABLE, OR A COMPUTER PROGRAM LISTING

Not Applicable

### BACKGROUND OF THE INVENTION

Cats are known for liking to curl up in the sun next to a window. Most modern houses do not have a ledge large enough for a cat to curl up on. There have been proposed a number of cat perches for attachment to windows. One proposed solution requires a strap with a stop that fits between the bottom of the window and the window seal, which keeps the window from sealing as tightly thus allowing heat to escape from the house. This solution also requires struts that rest against the wall below the window. This can result in marks being left on the wall.

Another solution uses four suction cups that attach to a window and suspension cables to form a shelf for the cat to sit on. One problem with this solution is that when the cat jumps onto the perch the suction cups are likely to slide slightly, resulting in a perch that is somewhat sloped. In addition, the structure of the shelf is made of plastic piping that has to be assembled by the customer. Finally, this structure does not provide a protective housing that many cats desire.

Thus there exists a need for an inexpensive, easy to assemble, detachable cat structure that attaches to a window and provides a protective housing.

### BRIEF SUMMARY OF INVENTION

A cat window structure that overcomes these and other problems has a number of glass attachment devices. A shell is connected to the glass attachment devices. The shell and a section of a window form a housing. An opening is formed in the housing. In one embodiment, the shell is made of a stiff fabric and the glass attachment devices are suction cups.

The shell provides a cradle to hold the cat, is inexpensive to make and ship, and the sling structure does not suffer from sliding when the cat jumps into or out of the structure.

### BRIEF DESCRIPTION OF THE SEVERAL VIEWS OF THE DRAWINGS

FIG. 1 is a top right perspective of a cat structure attached to a window in accordance with one embodiment of the invention;

FIG. 2 is a front view of a cat structure in accordance with one embodiment of the invention;

FIG. 3 is a side view of a suction cup in accordance with one embodiment of the invention;

FIG. 4 is a top view of a floor pad in accordance with one embodiment of the invention.

FIG. 5 is a top right perspective of a cat structure in accordance with one embodiment of the invention.

FIG. 6 is a top right perspective of a cat structure with a bubble pod in accordance with one embodiment of the invention.

FIG. 7 is an exploded view a cat structure with a bubble pod in accordance with one embodiment of the invention.

### DETAILED DESCRIPTION OF THE INVENTION

The invention is directed to cat window structure that has a number of glass attachment devices. A shell is connected to the glass attachment devices. The shell and a section of a window form a housing. An opening is formed in the housing. In one embodiment, the shell is made of a stiff fabric and the glass attachment devices are suction cups.

The shell provides a cradle to hold the cat, is inexpensive to make and ship, and the sling structure does not suffer from sliding when the cat jumps into or out of the structure.

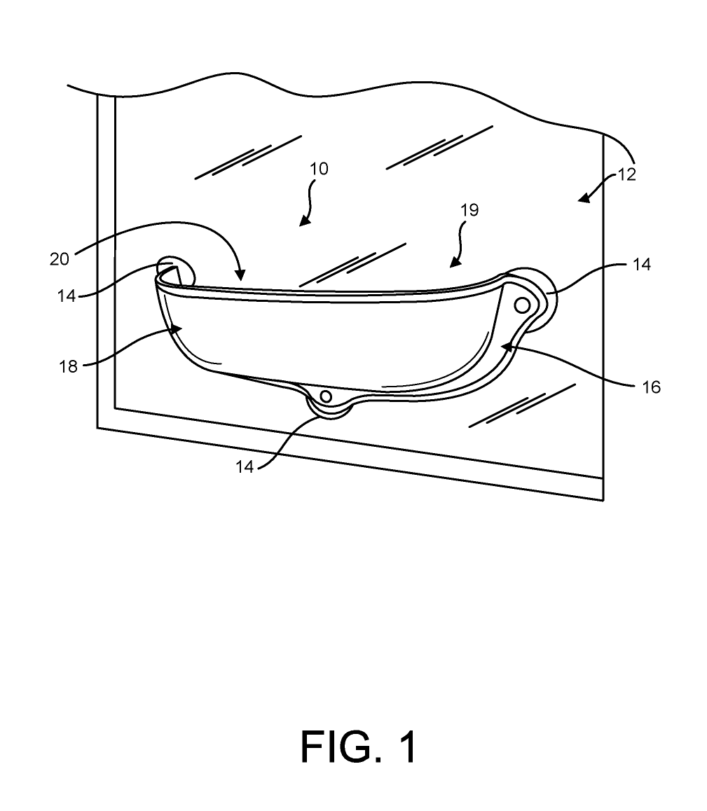

FIG. 1 is a top right perspective of a cat structure 10 attached to a window 12 in accordance with one embodiment of the invention. The cat window structure 10 has a number of attachment devices 14 that attach directly to the window 12. In one embodiment these window attachment devices 14 are suction cups. However, they could also be double sided tape, silly putty, hook and loop material or similar devices. The cat window structure 10 has a flange 16 that abuts the window 12 and has opening to connected to the suction cups 14. A shell 18 extends out from the flange 16 and the window 12. Together the shell 18 and the window 12 creates a housing 19 that a cat can lie in. There is an opening 20 for the cat to get in and out of the housing 19.

In one embodiment, the shell 18 is made of a fabric covered molded EVA foam, although the shell could be made from thermoformed or injection molded plastic, wood, metal, or other supportive materials.

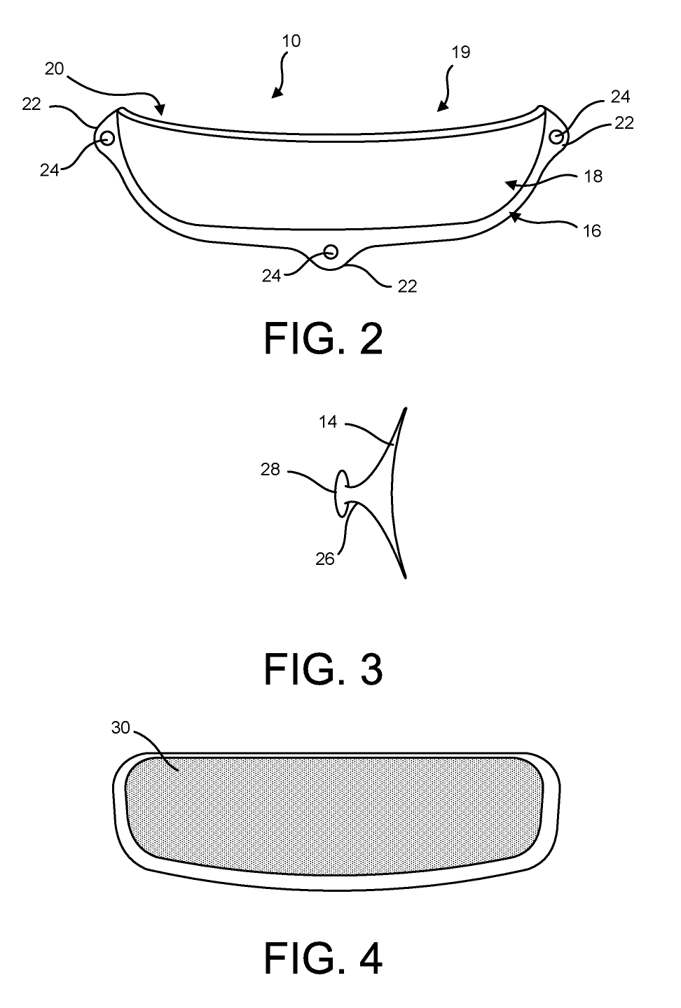

FIG. 2 is a front view of a cat structure 10 in accordance with one embodiment of the invention. In this view it is clear that the flange 16 has a plurality of tabs 22. The tabs 22 have openings 24. These openings 24 mate with a neck of the suction cups 14.

FIG. 3 is a side view of a suction cup 14 in accordance with one embodiment of the invention. The suction cup 14 has a neck 26 with a head 28.

FIG. 4 is a top view of a floor pad 30 in accordance with one embodiment of the invention. In one embodiment of the cat window structure 10 a floor pad is placed on the floor of the shell 18 and provides a cushion for the cat. The floor pad 30 may have a portion made of lamb's wool 32.

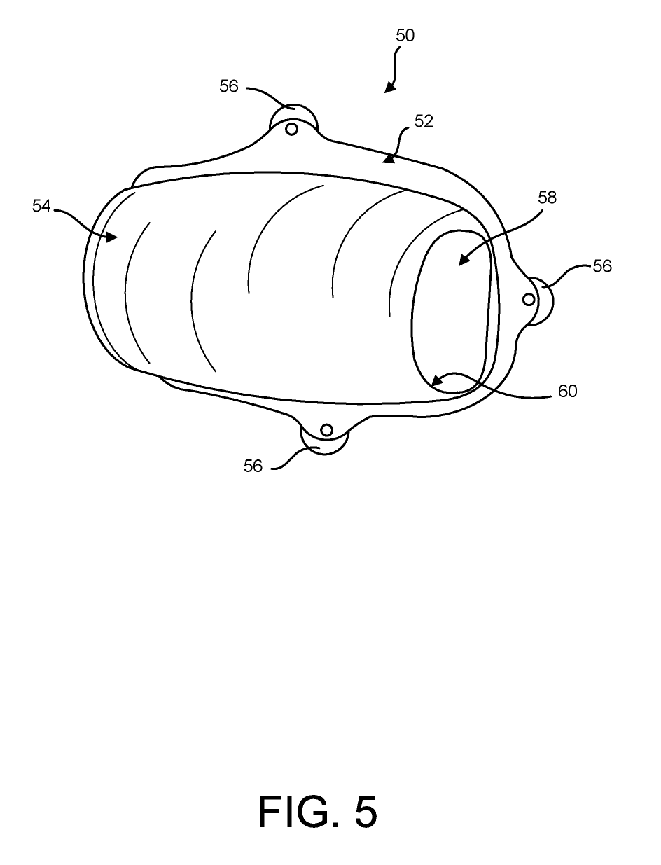

FIG. 5 is a top right perspective of a cat structure in accordance with one embodiment of the invention. This is alternative embodiment of the cat window structure 50. The structure 50 has flange 52 and a shell 54. It also uses suction cups 56 to hold the structure 50 to the window, wherein the window forms one of the walls of the housing. There is an opening 58 in the housing for a cat to enter and exit the structure 50. The shell 54 has a floor 60 that may have a floor pad. This structure 50 may be made of a stiff fabric in one embodiment.

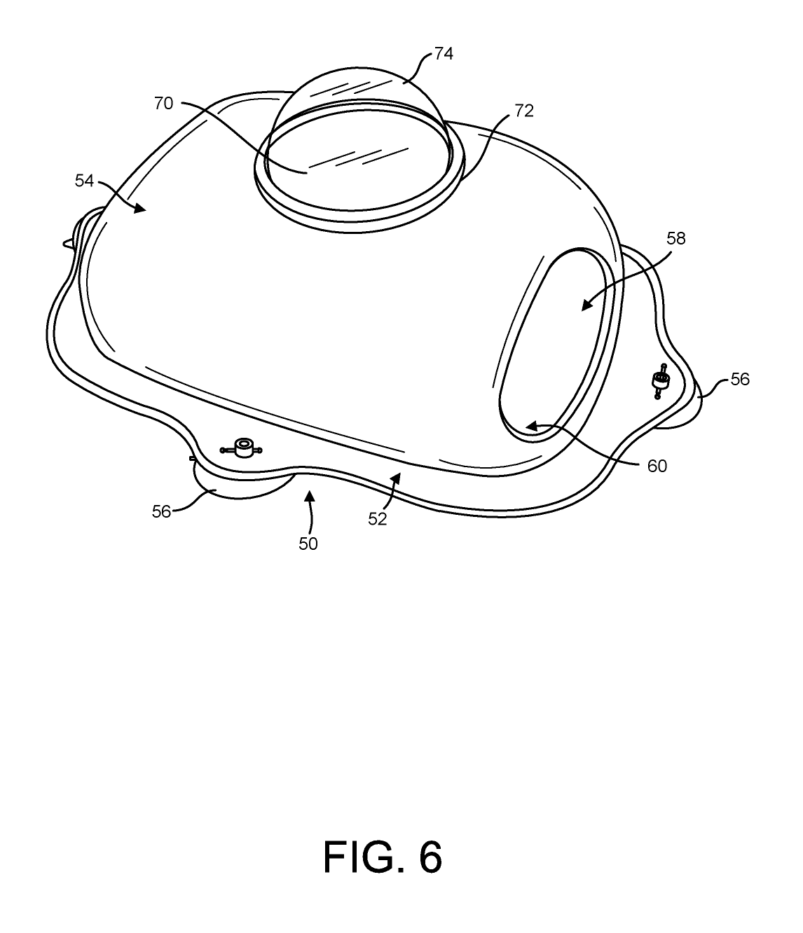

FIG. 6 is a top right perspective of a cat structure 50 with a bubble pod 70 in accordance with one embodiment of the invention. This cat structure is the same as that described in FIG. 5 except that there is a bubble pod 70 on the wall of the shell 54 opposite the open side that engages the window. The bubble pod 70 has a frame 72 and a clear plastic hemisphere 74. The bubble pod 70 allows the owner to see if the cat is in the housing and provides another play area to keep the cat engaged.

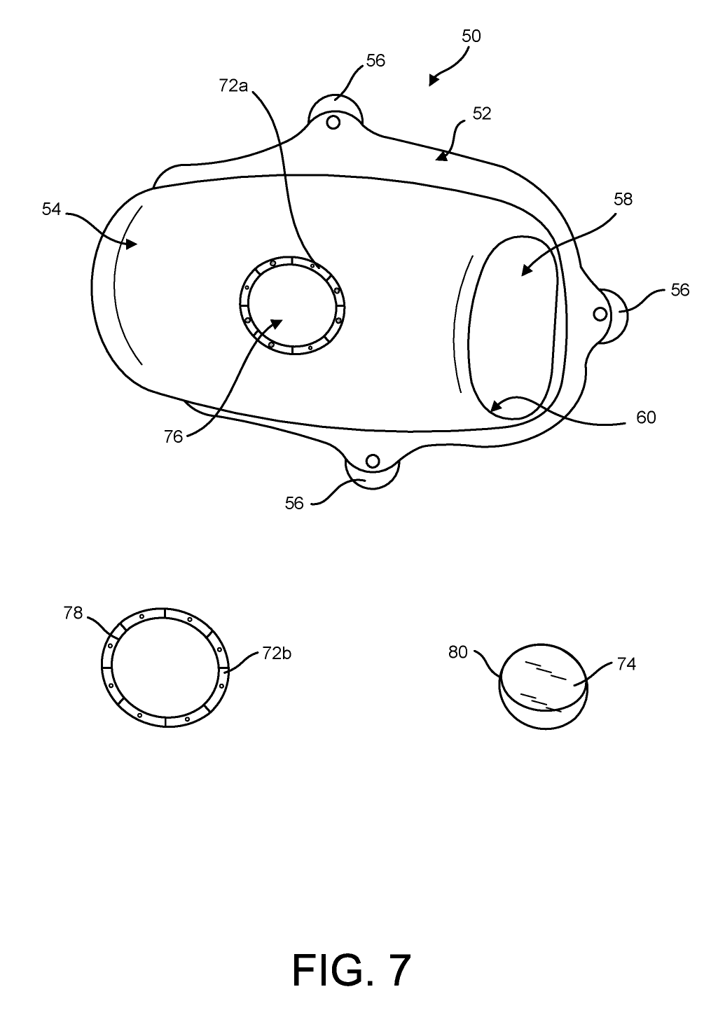

FIG. 7 is an exploded view a cat structure with a bubble pod in accordance with one embodiment of the invention. The bubble pod 70 is made of a two part flange 72. One part of the frame 72a forms a ring in the opening 76 in the shell 54. This may be held to the shell 54 by screws and may be made of a rigid plastic. A second part of the frame 72b is a ring with a curved up lip 78 that engages a lip 80 of the clear plastic hemisphere 74 when the frame 72b is attached to the frame 72a. The parts of the frame may be held together by screws or any other suitable mechanism.

Thus there has been described at cat window structure that shell provides a cradle to hold the cat, is inexpensive to make and ship, and the sling structure does not suffer from sliding when the cat jumps into or out of the structure.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A cat window structure with a bubble pod comprising:
a plurality of window attachment devices;
a housing having a periphery connected to the plurality of window attachment devices;
an opening in the housing; and
the bubble pod in a wall of the housing.

2. The cat window structure of claim 1, wherein the bubble pod is a clear plastic.

3. The cat window structure of claim 1, wherein the plurality of window attachment devices are suction cups.

4. The cat window structure of claim 2, wherein the bubble pod is mounted on the wall opposite the open end of the housing.

5. The cat window structure of claim 1, wherein the periphery of the housing is a flat flange that abuts a flat surface.

6. The cat window structure of claim 5, wherein the flat surface closes the open end of the housing.

7. A cat window structure with a bubble pod comprising:
a plurality of glass attachment devices;
a shell connected to the plurality of glass attachment devices, wherein the shell and a section of a window form a housing;
a bubble pod in the shell opposite the window; and
an opening in the housing.

8. The cat window structure of claim 7, wherein bubble pod has clear plastic shell.

9. The cat window structure of claim 8, wherein the plurality of glass attachment devices are suction cups.

10. The cat window structure of claim 9, wherein the housing is made of a fabric covered plastic.

11. The cat window structure of claim 9, wherein the housing has a flange along an edge that abuts the window.

12. The cat window structure of claim 9, wherein the housing has a lower section that abuts the window and an upper section that is spaced from the window.

13. The cat window structure of claim 9, wherein the housing has a peripheral that abuts the window and a center section that is spaced from the window to form an interior space.

14. The cat window structure of claim 9, wherein the housing has a floor.

15. A method of operating a cat window structure, comprising the steps of:
forming a structure having a bubble pod;
connecting a plurality of suction cups to the structure; and
attaching the plurality of suction cups to a window.

16. The method of claim 15, wherein the step of forming the structure includes the step of creating a fabric covered plastic shell that when attached to a window forms a housing.

17. The method of claim 16, wherein the step of forming a stiff fabric shell includes the step of creating an opening in the stiff fabric shell.

18. The method of claim 17, wherein the step of forming the structure includes creating the bubble pod with a clear plastic.
